(19) United States
(12) Patent Application Publication
(10) Pub. No.: US 2022/0272940 A1
(43) Pub. Date: Sep. 1, 2022

(54) Tie Out for Restraining Multiple Animals

(71) Applicant: Wigzi, LLC, Arlington, VA (US)

(72) Inventors: Nathan CHEFETZ, Kensington, MD (US); Cade Goldenberg, Great Falls, VA (US)

(21) Appl. No.: 17/677,368

(22) Filed: Feb. 22, 2022

Related U.S. Application Data
(60) Provisional application No. 63/154,263, filed on Feb. 26, 2021.

(51) Int. Cl. A01K 3/00; A01K 27/00

(52) U.S. Cl. CPC A01K 3/00; A01K 27/004

(57) ABSTRACT

A tie out for restraining multiple animals includes a frame having a central post, and an axle arranged perpendicularly to the central post, wherein the axle is rotatable about a vertical axis defined by the central post. The tie out may further include a first reel mounted on the axle and rotatable about a horizontal axis defined by the axle, and a first cable that is wound on the first reel. The tie out may further include a second reel mounted on the axle and rotatable about the horizontal axis, and a second cable wound on the second reel, wherein the first reel rotates around the axle independently of the second reel. The tie out further includes a cable guide arranged between the first reel and the second reel, wherein the cable guide is configured to prevent the first cable or the second cable from becoming tangled on the tie out.

### CROSS-REFERENCE TO RELATED APPLICATION

The present application claims the benefit of and priority to U.S. Provisional Application No. 63/154,263, filed on Feb. 26, 2021, which application is incorporated herein by reference in its entirety.

### FIELD

Embodiments described herein generally relate to a tie out for restraining multiple animals. Specifically, embodiments described herein relate to a tie out having a frame and a plurality of reels supported by the frame and having multiple axes of rotation.

### BACKGROUND

Tie outs are often used to secure an animal, such as a dog, in a given space, such as a backyard, lawn, camp ground or the like. The tie out allows the animal to roam freely within the space while preventing the animal from leaving the space or running away. Tie outs may be a simple, effective, and low cost solution to restrain an animal in a fixed location relative to installing a physical fence around the property or using a shock collar and a wireless electric fence, e.g., invisible fence.

### SUMMARY OF THE INVENTION

Some embodiments described herein relate to a tie out for restraining multiple animals that includes a frame having a central post, and an axle arranged perpendicularly to the central post, wherein the axle is rotatable about a vertical axis defined by the central post. The tie out further includes a first reel mounted on the axle and rotatable about a horizontal axis defined by the axle, a first cable having an end configured to be removably secured to a first animal, wherein the first cable is wound on the first reel, a second reel mounted on the axle and rotatable about the horizontal axis defined by the axle, and a second cable having an end configured to be removably secured to a second animal, wherein the second cable is wound on the second reel, and wherein the second reel rotates around the axle independently of the first reel. The tie out further includes a cable guide arranged between the first reel and the second reel, wherein the cable guide is configured to prevent the first cable or the second cable from becoming tangled on the tie out.

In any of the various embodiments described herein, the first cable is retractable on the first reel. In some embodiments, the first reel includes a biasing mechanism for retractable winding of the first cable on the first reel.

In any of the various embodiments described herein, the tie out further includes an anchor disposed on the frame, wherein the anchor is configured to facilitate securement of the frame to a support surface. In some embodiments, the anchor includes a pointed end. In some embodiments, the anchor includes a helical shape

In any of the various embodiments described herein, the axle includes a tubular sleeve rotatably mounted on the central post.

In any of the various embodiments described herein, the first reel is arranged parallel to the second reel.

In any of the various embodiments described herein, the first reel includes a casing defining an interior area in which the first cable is arranged, and wherein the casing defines a central aperture for receiving the axle.

In any of the various embodiments described herein, the first reel includes a length adjuster configured to set a length of the first cable that can be unwound from the first reel.

Some embodiments described herein relate to a tie out for restraining multiple animals that includes a frame having a central post and an axle including a tubular sleeve that is rotatably mounted on the central post, a first arm extending from the tubular sleeve, and a second arm extending from the tubular sleeve. The tie out includes a first reel rotatably mounted on the first arm of the axle, and a first cable wound on the first reel, wherein the first cable is retractable. The tie out includes a second reel rotatably mounted on the second arm of the axle, and a second cable wound on the second reel, wherein the second cable is retractable, and wherein the second reel rotates about the horizontal axis independently of the first reel. The tie out further includes a cable guide arranged between the first reel and the second reel, wherein the cable guide comprises an upper end, a lower end, and a sloped surface extending from the lower end to the upper end, and wherein the sloped surface of the cable guide is configured to guide the first cable or the second cable over the first and second reels to prevent tangling of the first cable or the second cable on the tie out.

In any of the various embodiments described herein, the sloped surface of the cable guide includes a curvature. In some embodiments, the cable guide includes a bell shape in a side view.

In any of the various embodiments described herein, the tie out further includes a base plate arranged on the central post.

In any of the various embodiments described herein, the tie out further includes an anchor connected to the frame and configured to secure the tie out to a support structure.

In any of the various embodiments described herein, the tie out further includes a connector configured to suspend the tie out from an overhead support structure.

Some embodiments described herein relate to a tie out for restraining multiple animals that includes a frame having an axle, wherein the axle is configured to rotate about a longitudinal axis of the frame. The tie out further includes a first reel mounted on the axle and rotatable about an axis defined by the axle, a first cable retractably wound on the first reel, a second reel mounted on the axle and rotatable about the axis defined by the axle, and a second cable retractably wound on the second reel, wherein the first reel rotates about the axis independently of the second reel. The tie out further includes a cable guide having a sloped surface, wherein the cable guide is arranged between the first reel and the second reel, and an anchor connected to the frame and configured to secure the tie out to a support structure.

In any of the various embodiments described herein, the sloped surface of the cable guide includes a curvature.

In any of the various embodiments described herein, the cable guide has a diameter that is greater than a diameter of the first reel.

In any of the various embodiments described herein, an upper end of the cable guide is arranged above an uppermost portion of the first reel.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows an exploded perspective view of a tie out for restraining multiple animals according to some embodiments.

FIG. 2 shows a transverse cross-sectional view of a reel of a tie out according to some embodiments.

FIGS. 3A and 3B show side views of a tie out according to some embodiments with a reel in a first position and a second position, respectively.

FIGS. 4A and 4B show top-down views of a tie out according to some embodiments as used to restrain two animals.

FIG. 5 shows a side view of a tie out having a cable guide according to some embodiments.

FIG. 6 shows a perspective view of a tie out installed for use according to some embodiments.

FIG. 7 shows a side view of a tie out according to some embodiments that is secured to an overhead support structure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the claims.

Animal owners often use tie outs, also referred to as tie-downs, to restrain an animal within a predetermined area while allowing the animal to have freedom of movement within that area. A simple tie out may include a post fixed in the ground, and a length of cable attached at one end to the post and at a second end to an animal's collar or harness. However, this type of tie out has numerous drawbacks.

The length of the cable may determine the range of the animal's movement, and having too short of a cable may overly limit the animal's movement while having a long cable may result in too much slack or excess cable. The slack in the cable may cause the cable to become tangled, stuck on an object, or wrapped around the post. The animal may become caught or tangled in the cable, which may pose a safety hazard.

These problems are exacerbated when securing multiple animals to the tie out. For example, if a first cable for a first animal is fixed to the post and a second cable for a second animal is fixed to the post, the two cables may become intertwined and tangled with one another. As a result, the owner may have to untangle the cables, which may be time consuming and frustrating.

Therefore, there is a need in the art for a tie out for restraining multiple animals that reduces the risk of tangling.

While the present application may refer to a tie out primarily for use with domestic animals, such as dogs and other pets, it is understood that the tie out may be used to restrain any of various animals, such as farm animals, or zoo animals, among others.

Some embodiments described herein relate to a tie out having a frame securable to the ground or other support structure, such as an overhead cable (e.g., clothesline or zipline) and two or more reels rotatably mounted on the frame. Each reel may have a cable wound thereon, and an end of the cable may be removably secured to an animal's collar, harness, or the like. In some embodiments, the frame may include a central post and an axle that is arranged perpendicularly to the central post and is rotatably mounted to the central post. Two or more reels may be rotatably mounted on the axle on opposing sides of the central post, and each reel may rotate independently of the other reel. In this way, the reels may rotate about a horizontal axis of the axle and about a vertical axis of the central post to accommodate various movements of the animals with respect to the tie out, preventing the cables from becoming tangled with one another or wrapping around the tie out.

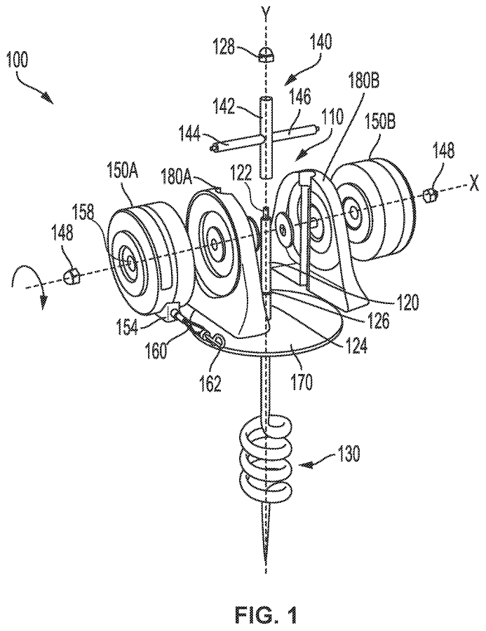

As shown in FIG. 1, a tie out 100 may include a frame 110 for supporting two or more reels 150 each having a length of cable 160 wound thereon. In some embodiments, frame 110 may include a central post 120 and an axle 140 arranged perpendicularly to central post 120 and rotatable about a vertical axis Y of central post 120. In some embodiments, central post 120 and axle 140 may form a plus-sign shape or cross shape. Axle 140 may be configured to rotate in 360 degrees about vertical axis Y. Each reel 150A, 15B is rotatably mounted on axle 140 and each reel 150A, 150B may rotate independently about axle 140. Thus, reels 150 may rotate around a horizontal axis X of axle 140, and further rotate about a vertical axis Y of central post 120. Tie out 100 may further include a cable guide 180 configured to prevent tangling of cables 160 around tie out 100 by guiding the cables over the tie out 100. Cable guide 180 may include two halves 180A, 180B that can be secured around frame 110 and joined together to form a cable guide 180. Cable guide 180 may be arranged between reels 150A, 150B, and may be rotatable about central post 120.

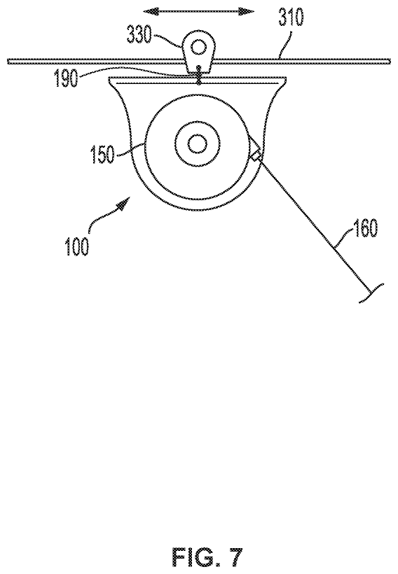

Tie out 100 may be installed for use by securing tie out 100 to a support surface or a support structure. In some embodiments, tie out 100 may include an anchor 130 configured to be secured to the ground. In some embodiments, tie out 100 may be configured to be supported by an overhead support structure, such as a cable, e.g., a clothes line or zip line (see, e.g., FIG. 7). In such embodiments, tie out 100 may include a connector 190 on frame 110 for facilitating connection of tie out 100 to overhead support structure.

In some embodiments, central post 120 may include an upper end 122 opposite a lower end 124. When tie out 100 is installed for use, central post 120 may be arranged in an upright orientation with upper end 122 arranged at a higher elevation than lower end 124. Central post 120 may be secured to a support surface, such as the ground. In some embodiments, frame 110 may include an anchor 130 configured to facilitate securement of tie out 100 to the ground. In some embodiments, anchor 130 may be arranged at lower end 124 of central post 120.

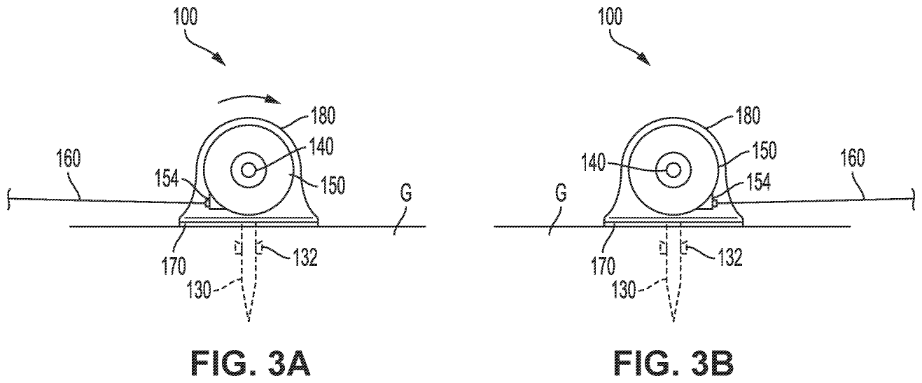

In some embodiments, anchor 130 may be integrally formed with frame 110. In some embodiments, anchor 130 may be secured to frame 110 by a mechanical fastener, an adhesive, or by a removable fastening device, such as by a threaded connection. Anchor 130 may include a rod having a pointed end for piercing the ground, such that anchor 130 resembles a stake. In some embodiments, anchor 130 may include one or more protrusions 132 (see, e.g., FIGS. 3A-3B) to prevent anchor 130 from being pulled out of the ground after being installed. Protrusions 132 may extend perpendicularly to a longitudinal axis of anchor 130 or may be arranged at an angle thereto. Protrusions 132 may help to make it more difficult for an animal, such as a dog, to pull the anchor 130 out of the ground by pulling on tie out 100. In some embodiments, anchor 130 may include a non-linear portion, and may have a corkscrew or helical shape (see, e.g., FIG. 1) to prevent removal of anchor 130 from the ground. Other configurations of anchor 130 are possible that ensure a secure and strong connection of tie out 100 to the ground.

In some embodiments, tie out 100 may further include a base plate 170 arranged at a lower end 124 of central post 120, as shown for example in FIG. 1. Base plate 170 may be fixed to lower end 124 of central post 120. Base plate 170 may be configured to rest against a support surface, such as the ground, when tie out 100 is installed. Base plate 170 may be substantially planar. Base plate 170 may include a disk shape as shown in FIG. 1. However, in alternate embodiments, base plate 170 may include other shapes, such as a square shape, a rectangular shape, or an oval shape, among others.

In some embodiments, axle 140 of frame 110 may include a tubular sleeve 142 and a pair of arms 144, 146 arranged on and extending outwardly from opposing sides of tubular sleeve 142. Arms 144, 146 may be integrally formed with tubular sleeve 142 or may be permanently secured to tubular sleeve 142. Arms 144, 146 may be arranged along a common horizontal axis X. Arms 144, 146 may be spaced from one another by 180 degrees. Tubular sleeve 142 of axle 140 may be placed around central post 120, such that central post 120 is received within tubular sleeve 142, so that axle 140 may rotate around vertical axis Y of central post 120.

In some embodiments, central post 120 may include a flange 126 extending circumferentially about central post 120. Tubular sleeve 142 of axle 140 may be seated on flange 126 so as to support axle 140 at a fixed longitudinal position along central post 120. With tubular sleeve 142 of axle 140 installed on central post 120, a cap 128 may be placed on upper end 122 of central post 120 to prevent tubular sleeve 142 from moving beyond upper end 122 of central post 120. In some embodiments, cap 128 may be secured to upper end 122 of central post 120 by a removable connection, such as by a threaded connection, bayonet coupling, or friction fit, among others.

In some embodiments, axle 140 of frame 110 may not include a tubular sleeve and may instead be formed as a linear rod having a central aperture, wherein central post 120 is arranged through the central aperture of axle 140. One of ordinary skill in the art may readily envision other constructions that allow for rotation of axle 140 about a vertical axis of a central post 120.

In some embodiments, tie out 100 may include two or more reels 150 on which a length of cable 160 is wound. Each reel 150 may be rotatably mounted on axle 140 of frame 110. Each reel 150A, 150B may be configured to rotate about a horizontal axis X defined by axle 140 in 360 degrees. Each reel 150A, 150B may rotate independently of the other reel 150A, 150B. For example, a first reel may remain stationary while a second reel rotates about axle 140. Each reel 150 may be arranged in a vertical plane, and reels 150 may be arranged parallel to one another. Each reel 150A, 150B may include a central aperture 158 so that axle 140 is received through central aperture 158 of each reel 150. A cap 148 may be arranged on each end of axle 140 to help maintain reels 150 on axle 140. In some embodiments, cap 148 may be secured to each end of axle 140 by a removable connection, such as by a threaded connection, bayonet coupling, or friction fit, among others.

In some embodiments, as shown in FIG. 1, a first reel 150A may be arranged on a first arm 144 of axle 140, and a second reel 150B may be arranged on a second arm 146 of axle 140. Thus, reels 150 may be arranged on opposing sides of central post 120 and central post 120 may be arranged between reels 150A, 150B. Arranging reels 150A, 150B on opposing sides of central post 120 may balance the weight of the reels and may facilitate rotation of axle 140 around central post 120. Further, as reels 150A, 150B are arranged on opposing sides of central post 120, forces exerted on frame 110 by the animals secured to the cable of each reel may be better balanced.

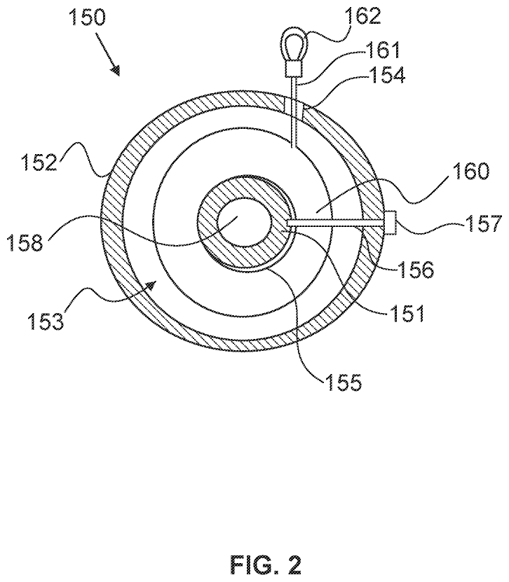

In some embodiments, as shown in FIG. 2, each reel 150 may include a casing 152 defining an interior area 153 for storing the wound cable 160. Casing 152 may define a central aperture 158 such that casing 152 has an annular shape. Central aperture 158 is configured to receive axle 140 of frame 110 therethrough, as discussed above. Cable 160 may be wound around a central portion 151 of reel 150. Cable 160 may be retractably wound on reel 150 and may rotate within casing 152 to wind and unwind a length of cable 160. Reel 150 may include a biasing mechanism 155, such as a spring, for biasing the cable in the wound position. Cable 160 may be unwound by applying a force to cable sufficient to overcome the biasing mechanism 155. As cable 160 is unwound, tension is maintained in cable 160 by biasing mechanism 155 which helps to minimize slack in cable 160 to prevent cable 160 from becoming tangled or wrapped around an object. Casing 152 may define a cable aperture 154 through which cable 160 may pass from interior area 153 to an exterior of casing 152. Cable aperture 154 may be arranged on a perimeter of casing 152. An end 161 of cable 160 may include a fastener 162, such as a loop or a clip, such as a spring-loaded clip or carabiner, for removable connection to a collar of an animal. Fastener 162 may be sized greater than a size of cable aperture 154 to prevent end 161 of cable 160 from passing through cable aperture 154 into interior area 153 of casing 152.

In some embodiments, each reel 150 may include a length adjuster 156 configured to set the maximum length of cable 160 that can be unwound from reel 150. For example, if cable 160 has a total length of 30 feet, length adjuster 156 may be used to set the length extendable from reel 150 to the total length or to a length that is less than the total length, such as 25 feet, 20 feet, or 15 feet, etc. This may be useful, for example, where the total length of cable 160 is greater than the size of the area in which the tie out 100 is installed.

Length adjuster 156 may include an actuator 157, such as a knob, dial, button, level, or the like, that can be operated by a user to set the length of cable 160 that can be unwound from a reel 150. Actuator 157 of length adjuster 156 may be arranged on casing 152 of reel 150 for easy access by a user. Length adjuster 156 may include a braking mechanism to control a maximum length of cable that may be unwound from reel. Any of various braking mechanisms that allow for setting the length of cable to be unwound may be used in accordance with the present disclosure, as will be appreciated by one of ordinary skill in the art. A braking mechanism is disclosed for example in U.S. Pat. No. 8,256,385 B2, which is incorporated herein by reference in its entirety.

In some embodiments, length adjuster 156 may be configured to allow the length of cable 160 to be adjusted to any desired length. In some embodiments, length adjuster 156 may adjust the length of cable 160 in fixed increments, such as increments of 6 inches, 12 inches, 18 inches, or 24 inches, among other increments. In some embodiments, a single length adjuster 156 may set the length of cable that can be unwound from both reels 150A, 150B. However, in some embodiments, each reel may include its own length adjuster 156 such that the length of cable that may extend from each reel can be set independently of the other reel. This may be desirable where the user wishes to provide one animal with a greater area to roam than a second animal.

As shown in FIGS. 3A and 3B, tie out 100 is installed in ground G for use. Tie out 100 includes an anchor 130 having protrusion 132 engaged within the ground G. A base plate 170 of tie out 100 rests on a surface of ground G. Each reel 150 of tie out 100 may rotate about axle 140. As an animal moves relative to tie out 100, reel 150 may rotate about axle 140 in either direction, such as in a clockwise or counterclockwise direction, and in 360 degrees around axle 140 so that cable aperture 154 of reel 150 is closest to the animal's location. For example, in FIG. 3A, the animal pulls the cable 160 toward a left side of tie out 100 and thus reel 150 rotates so that cable aperture 154 is arranged on the left side of reel 150. If the animal moves to the right side of tie out 100, as shown in FIG. 3B, reel 150 may rotate around axle 140 in a clockwise direction so that cable aperture 154 is rotated toward the right side of reel 150. This helps to prevent the cable 160 from wrapping around reel 150 as the animal moves relative to tie out 100.

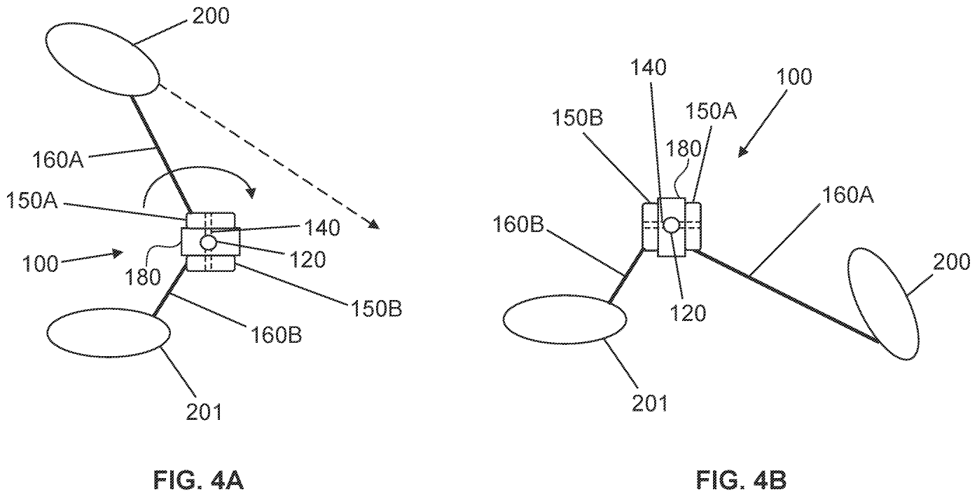

As shown in FIGS. 4A and 4B, two animals may be restrained by tie out 100. In FIG. 4A, a first animal 200 is restrained by a first cable 160A of a first reel 150A, and a second animal 201 is restrained by a second cable 160 of a second reel 150B. As each animal moves, first reel 150A and second reel 150B may rotate about axle 140 independently of one another, and axle 140 may rotate around central post 120. If the first animal 200 moves to a different location, e.g., from the location shown in FIG. 4A to the location shown in FIG. 4B, axle 140 may rotate about central post 120 so that first reel 150A rotates closer to the position of first animal 200. This may help to prevent the first cable 160A from wrapping around tie out 100 as may otherwise occur if axle 140 did not rotate about central post 120. As first and second reels 150A, 150B are both mounted to axle 140, separation is maintained between first and second reels 150A, 150B, and between first and second cables 160A, 160B as axle 140 rotates about central post 120. Cable guide 180 rotates with axle 140 as axle 140 rotates about central post 120.

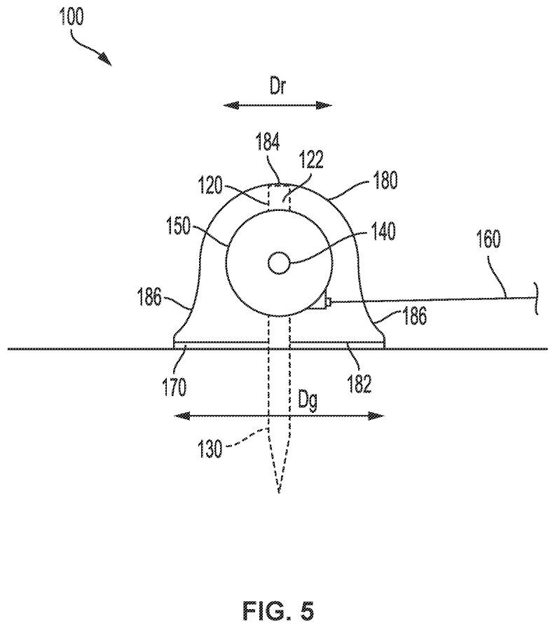

As shown in FIG. 5, tie out 100 may include a cable guide 180 configured to prevent a cable 160 from passing under a reel 150 and becoming caught or tangled underneath a reel 150 or around central post 120. Cable guide 180 may include a sloped surface configured to guide a cable over tie out 100, such that cable guide 180 may serve as a ramp. Cable guide 180 may be arranged on frame, such as on axle 140 of frame. Cable guide 180 may be positioned between first and second reels 150A, 150B, such that each reel 150A, 150B is in contact with a side of cable guide 180. Cable guide 180 is arranged above base plate 170. Cable guide 180 may be the uppermost portion of tie out 100.

Cable guide 180 may be arranged in a vertical plane that is generally parallel to each reel 150. Cable guide 10 may include an upper end 184 arranged adjacent upper end 122 of central post 120, and a lower end 182 that is arranged at or just above ground level. Cable guide 180 may be positioned around central post 120 and may rotate as axle 140 rotates such that cable guide 180 does not impede rotation of axle 140. In some embodiments, cable guide 180 may be connected to the tubular sleeve of axle 140. Lower end 182 of cable guide 180 may be arranged on or close to ground or base plate 170 so that a cable 160 may not pass underneath cable guide 180. However, some clearance between lower end 182 of cable guide 180 and the ground or base plate 170 may help to allow for free rotation of axle 140 and cable guide 180.

In some embodiments, cable guide 180 may have a sloped surface 186 that slopes downwardly from upper end 184 toward lower end 182 of cable guide 180. Sloped surface 186 may slope upwardly from lower end 182 of cable guide 180 on a first side of first reel 150 to upper end 184 of cable guide 180 adjacent upper end 122 of central post 120 and may slope downwardly toward lower end 182 of cable guide 180 on a second, opposing side of first reel 150. Sloped surface 186 may be arranged at an angle to a vertical axis of central post 120 so as to serve as a ramp along which cables 160 may slide over tie out 100 to avoid becoming tangled on tie out 100. Sloped surface 186 may be generally linear or planar, or may have a curvature. In some embodiments, cable guide 180 may have a triangular shape, a semi-circular shape, or a bell-shape in a side view, among others. Cable guide 180 may have a maximum diameter D_{g} that is greater than a maximum diameter Dᵣ of each reel 150. Further, upper end 184 of cable guide 180 may be arranged at or above an uppermost portion of first and second reels 150, 160. In operation, if a cable 160 of a first reel 150 is pulled in a direction toward a second reel 150, cable 160 may contact cable guide 180 rather than second reel 150, and sloped surface 186 of cable guide 180 may urge cable 160 toward upper end 184 of cable guide 180 and over tie out 100 in order to prevent cable from passing underneath reels 150 or otherwise becoming tangled around tie out 100.

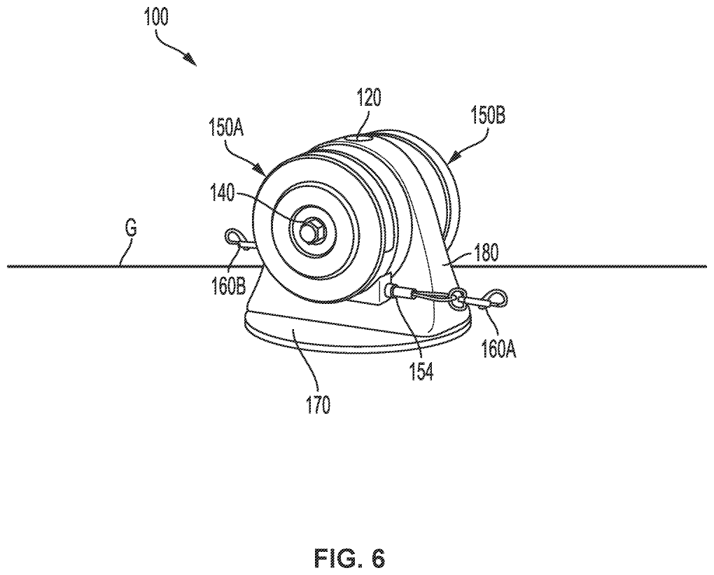

In operation, tie out 100 may be installed in the ground for use as shown for example in FIG. 6. In use, tie out 100 may be installed in the ground G by inserting an anchor into the ground such that central post 120 is in an upright orientation and is substantially vertical. In embodiments having a base plate as shown in FIG. 6, base plate 170 is arranged on a surface of the ground G. In some embodiments in which tie out 100 includes a cable guide 180, a lower end of cable guide 180 is arranged at or slightly above ground level or at or slightly about surface of base plate 170. Reels 150 are arranged on opposing sides of cable guide 180, and a lower end of reel 150 is spaced from ground and base plate 170. An end of a first cable 160A of a first reel 150A may be secured to a first animal, such as to a collar of a first dog, and an end of a second cable 160B of second reel 150B may be secured to a second animal, such as to the collar of a second dog. As each dog moves a greater distance away from tie out 100, additional cable 160 is unwound from the respective reel to allow the animal to move farther away from tie out 100, and as each animal moves toward tie out 100, the cable automatically retracts into reel such that cable 160 is maintained under tension. As the animals move around tie out 100, axle 140 may rotate about vertical axis of central post 120 to accommodate the motion of the dogs and to prevent cables 160A, 160B from becoming tangled with one another or wrapping around tie out 100. Further, as a first animal moves, the first reel 150A may rotate about axle 140 independently of second reel 150B in order to move cable aperture 154 closer to the location of the first animal, and similarly as the second animal moves, second reel 150B may rotate about axle 140 independently of first reel 150. If one animal moves around tie out 100 such that cable 160 is drawn toward the tie out 100, cable 160 may contact cable guide 180 and may pass along a sloped surface of cable guide 180 to move cable 160 over tie out 100 to prevent tangling.

In some embodiments, tie out 100 may be secured to an overhead support structure as shown in FIG. 7. Overhead support structure may include for example a roof or ceiling, or an overhead support line (e.g., a zip line, clothes line, or the like). A support line 310 may extend between two structures, e.g., posts, buildings (such as a house, garage, or shed). Support line 310 may be arranged generally parallel to the ground. Tie out 100 may include a connector 190 configured to facilitate connection of tie out 100 to support line 310 or to a pulley 330 or other device arranged on support line 310. Pulley 330 may be movable along support line 310 such that pulley 330 and tie out 100 connected thereto may move along length of support line 310. Connector 190 may include for example, an eyelet or opening to receive a line or a fastener, such as a clip. In some embodiments, connector 190 may include a fastener, such as a hook or clip, to attach tie out 100 to a support line 310, pulley 330, or other support structure. Connector 190 may be arranged for example on frame or cable guide 180 of tie out 100. Thus, tie out 100 may operate in the same manner as described herein, in which axle may rotate about the frame, and reels 150 may rotate about the axle, with the frame of tie out 100 being secured to support line 310.

In such embodiments, tie out 100 may be installed so as to be suspended above the ground. Cables 160 may extend from reels 150 downwardly toward the ground. In embodiments in which tie out 100 is installed by connection to an overhead support structure, tie out 100 may not include a cable guide 180. Instead, as cables are angled downwardly toward the ground from tie out 100, cables 160 may pass underneath tie out 100 in space between tie out 100 and the ground. Thus, cables 160 may pass freely underneath tie out 100 without risk of tangling.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

What is claimed is:

1. A tie out for restraining multiple animals, comprising:
a frame comprising:
a central post, and
an axle arranged perpendicularly to the central post, wherein the axle is rotatable about a vertical axis defined by the central post;
a first reel mounted on the axle and rotatable about a horizontal axis defined by the axle;
a first cable having an end configured to be removably secured to a first animal, wherein the first cable is wound on the first reel;
a second reel mounted on the axle and rotatable about the horizontal axis defined by the axle;
a second cable having an end configured to be removably secured to a second animal, wherein the second cable is wound on the second reel, and wherein the second reel rotates around the axle independently of the first reel; and
a cable guide arranged between the first reel and the second reel, wherein the cable guide is configured to prevent the first cable or the second cable from becoming tangled on the tie out.

2. The tie out of claim 1, wherein the first cable is retractable on the first reel.

3. The tie out of claim 2, wherein the first reel comprises a biasing mechanism for retractable winding of the first cable on the first reel.

4. The tie out of claim 1, further comprising an anchor disposed on the frame, wherein the anchor is configured to facilitate securement of the frame to a support surface.

5. The tie out of claim 4, wherein the anchor comprises a pointed end.

6. The tie out of claim 4, wherein the anchor comprises a helical shape.

7. The tie out of claim 1, wherein the axle comprises a tubular sleeve rotatably mounted on the central post.

8. The tie out of claim 1, wherein the first reel is arranged parallel to the second reel.

9. The tie out of claim 1, wherein the first reel comprises a casing defining an interior area in which the first cable is arranged, and wherein the casing defines a central aperture for receiving the axle.

10. The tie out of claim 1, wherein the first reel comprises a length adjuster configured to set a length of the first cable that can be unwound from the first reel.

11. A tie out for restraining multiple animals, comprising:
a frame comprising:
a central post;
an axle comprising a tubular sleeve that is rotatably mounted on the central post, a first arm extending from the tubular sleeve, and a second arm extending from the tubular sleeve;
a first reel rotatably mounted on the first arm of the axle;
a first cable wound on the first reel, wherein the first cable is retractable;
a second reel rotatably mounted on the second arm of the axle;
a second cable wound on the second reel, wherein the second cable is retractable, and wherein the second reel rotates about the axle independently of the first reel; and
a cable guide arranged between the first reel and the second reel, wherein the cable guide comprises an upper end, a lower end, and a sloped surface extending from the lower end to the upper end, wherein the sloped surface of the cable guide is configured to guide the first cable or the second cable over the first and second reels to prevent tangling of the first cable or the second cable on the tie out.

12. The tie out of claim 11, wherein the sloped surface of the cable guide comprises a curvature.

13. The tie out of claim 12, wherein the cable guide comprises a bell shape in a side view.

14. The tie out of claim 11, further comprising a base plate arranged on the central post.

15. The tie out of claim 11, further comprising an anchor connected to the frame and configured to secure the tie out to a support structure.

16. The tie out of claim 11, further comprising a connector configured to suspend the tie out from an overhead support structure.

17. A tie out for restraining multiple animals, comprising:
a frame comprising an axle, wherein the axle is configured to rotate about a longitudinal axis of the frame;
a first reel mounted on the axle and rotatable about an axis defined by the axle;
a first cable retractably wound on the first reel;
a second reel mounted on the axle and rotatable about the axis defined by the axle;
a second cable retractably wound on the second reel, wherein the first reel rotates about the axis independently of the second reel;
a cable guide comprising a sloped surface, wherein the cable guide is arranged between the first reel and the second reel; and
an anchor connected to the frame and configured to secure the tie out to a support structure.

18. The tie out of claim 17, wherein the sloped surface of the cable guide comprises a curvature.

19. The tie out of claim 17, wherein the cable guide comprises a diameter that is greater than a diameter of the first reel.

20. The tie out of claim 17, wherein an upper end of the cable guide is arranged above an uppermost portion of the first reel.
